(19) United States
(12) Patent Application Publication
(10) Pub. No.: US 2002/0004734 A1
(43) Pub. Date: Jan. 10, 2002

(54) Schedule managing apparatus and method and computer-readable recording medium storing schedule managing program therein

(76) Inventor: Shinichiro Nishizawa, Kawasaki (JP)

Correspondence Address: STAAS & HALSEY LLP, 700 11TH STREET, NW, SUITE 500, WASHINGTON, DC, 20001, US

(21) Appl. No.: 09/764,301

(22) Filed: Jan. 19, 2001

(30) Foreign Application Priority Data
Jul. 10, 2000 (JP) 2000-208298

(51) Int. Cl. G06F 17/60; G06F 17/30

(52) U.S. Cl. 705/9; 707/104.1; 707/201

(57) ABSTRACT

A new schedule inputted as a ToDo list by a schedule classifying unit is classified into any schedule type of a term type in which it is necessary to be conscious of designated date/time as a term of the operation or a period type in which it is necessary to assure a designated certain period for the operation and the classified schedule is displayed. If the inputted new schedule overlaps with an existing schedule with respect to the time, a schedule adjusting unit adjusts the schedules on the basis of the schedule type of the term type or period type.

### BACKGROUND OF THE INVENTION

1. Field of the Invention

The present invention relates to schedule managing apparatus and method for managing schedule information which is inputted into a ToDo list or the like and to a computer-readable recording medium in which a schedule managing program has been stored. More particularly, the invention relates to schedule managing apparatus and method in which when a new schedule is inputted, adjustment between the new schedule and an existing schedule is automatically performed by analyzing the contents of the schedules and to a computer-readable recording medium in which a schedule managing program has been stored.

2. Description of the Related Arts

Hitherto, in an information processing apparatus such as portable terminal, personal computer, or the like for personal use, a personal information managing system known as PIM (Personal Information Manager) or PDA (Personal Data Assistant) has been used. Such a personal information managing system has the following managing functions of personal information therein: namely, a schedule management to form and manage schedule tables such as monthly schedule table, weekly schedule table, daily schedule table, and the like; a ToDo management to set and manage operation items such as formation of conference materials or the like indicative of what the user should execute for which purpose; an address book management to form and manage an address book; and the like. In this instance, when an application to manage the ToDo list is considered, the operation items indicative of the operations which the user has to do by himself due to a request, notification, or the like from another person are inputted to the ToDo list. In many cases, the operation items which are inputted are schedule information such as “which ones are executed until what time”, “where and what day and time to go” and the like. Consequently, as a managing application, there are required functions for inputting the schedule information from the ToDo list and forming and managing schedule tables such as monthly schedule table, weekly schedule table, daily schedule table, and the like.

However, in the conventional schedule managing application, in the case where the user inputs new operation items into the ToDo list, if there is existing schedule information overlapping with inputted new schedule information with respect to the time, it is added as it is into the schedule table such as weekly schedule, monthly schedule, or the like. An adjustment of the overlapped schedules depends on the user. Although there is also a schedule managing application for displaying a warning in the case where schedules overlap when they are overlapped, the adjustment fundamentally depends on the user. Accordingly, there is such a problem that when the user sets new operation items into the ToDo list and schedule information is inputted, the adjusting operation between the existing schedule and the newly inputted schedule is complicated.

### SUMMARY OF THE INVENTION

According to the invention, schedule managing apparatus and method for automatically adjusting an inputted new schedule and an existing schedule on the basis of their schedule information are provided and a computer-readable recording medium in which a schedule managing program has been stored is provided.

According to the invention, there is provided a schedule managing apparatus for managing schedules, comprising: a schedule classifying unit which classifies an inputted schedule into any type on the basis of its information; and a schedule adjusting unit which, when the inputted schedule overlaps with the existing schedule with respect to the time, adjusts the schedules on the basis of each schedule type. The schedule classifying unit classifies the schedule into a type of either a term type schedule for setting designated date/time to a term of the operation or a period type schedule for assuring a designated certain period for the purpose of operation. A schedule managing apparatus of the invention comprises: a schedule classifying unit which classifies an inputted new schedule into any type of either a term type schedule in which it is necessary to be conscious of designated date/time as a term of the operation or a period type schedule in which it is necessary to assure a designated certain period for the purpose of the operation and displays the classified type; and a schedule adjusting unit which, when the inputted new schedule overlaps with an existing schedule with respect to the time, adjusts the schedule on the basis of the schedule type of the term type or period type classified by the schedule classifying unit. According to the invention as mentioned above, since the schedules are classified into two types of the term type and the period type and they are displayed on the schedule table such as monthly schedule, weekly schedule, and the like, the user can clearly grasp whether he should be conscious of the term (closure) or the attendance for a certain period for the displayed schedule.

The schedule classifying unit classifies the schedule into the schedule type of the term type schedule or the period type schedule on the basis of schedule information that is inputted into the ToDo list, for example, on the basis of the schedule information including an item regarding date/time, an item regarding a place, an item regarding persons concerned, an item regarding the contents, an item regarding priority, and an item such as a schedule adjustment or the like regarding the system. When the inputted new schedule overlaps with the existing schedule with respect to the time, the schedule adjusting unit adjusts the schedules on the basis of the schedule types of the term type and the period type classified by the schedule classifying unit. Overlapping patterns of the schedules serving as adjustment targets are classified into the following three types.

Overlap of the term type and the term type

Overlap of the period type and the period type

Overlap of the term type and the period type

First, adjustment in the case where the term type schedule and the term type schedule are overlapped will now be described. When both an inputted new schedule and an existing schedule are the term type schedules and their terms are overlapped, the schedule adjusting unit adds the new schedule as it is without adjusting them. Even if the terms of the two term type schedules are overlapped, since there is no problem on the schedule, the new schedule is added as it is. Subsequently, adjustment in the case where the period type schedule and the period type schedule are overlapped will now be explained. When the inputted new schedule and the existing schedule are the period type schedules and their periods are overlapped, the schedule adjusting unit adjusts them so as to leave the schedule having high priority. When the priority of the inputted new schedule and that of the existing schedule are the same, the schedule adjusting unit leaves the schedule selected in accordance with preset conditions. As conditions in the case where the priority is the same, one of the modes of the user's selection, the selection of the existing schedule, and the selection of a new schedule can be selected and set. Adjustment in the case where the term type schedule and the period type schedule are overlapped will now be described. In the case where one of the inputted new schedule and the existing schedule is the term type schedule and the other is the period type schedule, when the priority of the term type schedule is higher, the schedule adjusting unit adjusts them so as to move the term type schedule to a period start position of the period type schedule. When the priority of the term type schedule is lower, the schedule adjusting unit adjusts them so as to move the term type schedule to, for example, a period end position of the period type schedule. When the user sets new operation items on such a ToDo list and schedule information is inputted, the schedule adjustment between the existing schedule and the newly inputted schedule is automatically performed, so that the user's burden for the schedule adjusting operation can be extremely reduced.

The schedule managing apparatus of the invention further comprises a schedule history managing unit for storing the schedule deleted due to the adjustment by the schedule adjusting unit and a position before the adjustment of the schedule moved by the adjustment. In this case, when the existing schedule is deleted, the schedule adjusting unit refers to the history stored by the schedule history managing unit, recovers the schedule deleted by the schedule adjustment, or returns the schedule to the initial position moved due to the schedule adjustment. By storing the schedule deleted by the schedule adjustment and the position before the adjustment as a history as mentioned above, when the existing schedule is deleted, the schedule which became the adjustment target due to the presence of the existing schedule is read out from the history and recovered or the position is returned to the original position, so that the adjustment can be simply performed when the schedule is deleted.

According to the invention, there is provided a schedule managing method of managing schedules, comprising:

a schedule classifying step which classifies an inputted schedule into any type on the basis of its information; and

a schedule adjusting step which, when the inputted schedule overlaps with an existing schedule with respect to the time, adjusts the schedules on the basis of a type of each schedule.

According to the invention, there is further provided a computer-readable recording medium in which a schedule managing program for managing schedules has been stored, wherein the program comprises:

a schedule classifying step which classifies an inputted schedule into any type on the basis of its information; and

a schedule adjusting step which, when the inputted schedule overlaps with an existing schedule with respect to the time, adjusts the schedules on the basis of a type of each schedule.

The above and other objects, features, and advantages of the present invention will become more apparent from the following detailed description with reference to the drawings.

### BRIEF DESCRIPTION OF THE DRAWINGS

FIG. 1 is a block diagram of an example of a hardware construction of the invention;

FIG. 2 is a functional block diagram as an embodiment of a schedule managing module according to the invention;

FIG. 3 is an explanatory diagram of a schedule list and a schedule record stored in a schedule storing area in FIG. 2;

FIG. 4 is an explanatory diagram of a ToDo forming picture plane which is used for inputting schedule information in the invention;

FIG. 5 is a flowchart for a whole schedule managing process according to the invention;

FIG. 6 is a flowchart for a schedule classifying process according to the invention;

FIGS. 7A and 7B are explanatory diagrams of a specific example of a schedule table and a schedule list formed in the invention;

FIGS. 8A an 8B are flowcharts for a schedule adjusting process according to the invention;

FIGS. 9A to 9C are explanatory diagrams of a specific example of adjusting schedules between the term type schedule and the term type schedule;

FIGS. 10A to 10C are explanatory diagrams of a specific example of adjusting schedules between the period type schedule and the period type schedule;

FIGS. 11A to 11C are explanatory diagrams of a specific example of adjusting schedules between the term type schedule and the period type schedule;

FIG. 12 is a flowchart for a schedule history storing process according to the invention; and

FIGS. 13A and 13B are explanatory diagrams of a specific example of returning a moved schedule due to the adjustment to an original position at the time when the adjusted term type schedule is deleted.

### DETAILED DESCRIPTION OF THE PREFERRED EMBODIMENT

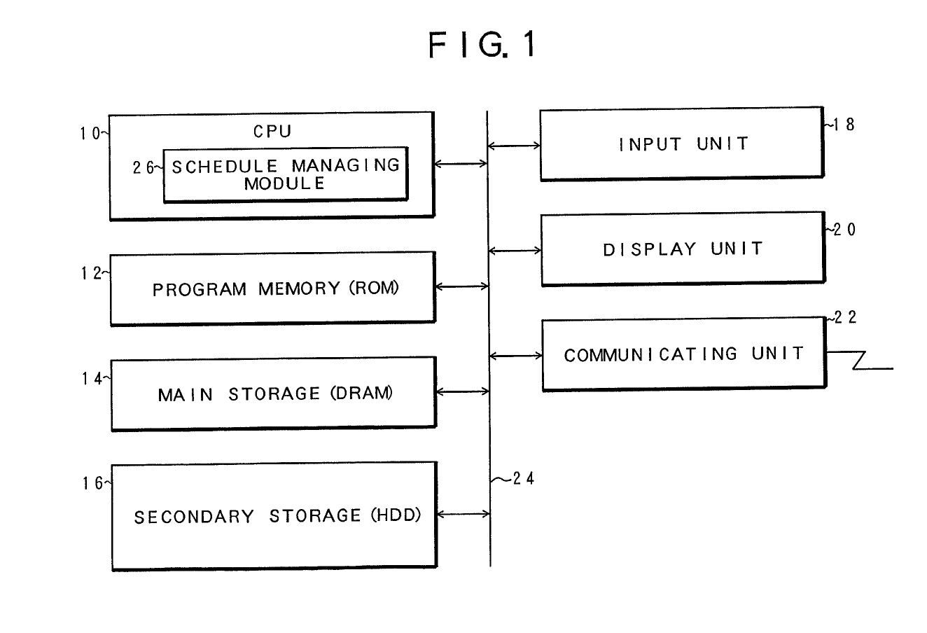

FIG. 1 is a diagram showing an example of a hardware construction to which a schedule managing apparatus of the invention is applied. The schedule managing apparatus comprises: a CPU 10; a program memory 12 using an ROM; a main storage 14 using a DRAM or the like; a secondary storage 16 using a hard disk drive (HDD); an input unit 18 using a keyboard, a mouse, a touch pen tablet, or the like; a display unit 20 using a CRT, a liquid crystal display, or the like; and further, a communicating unit 22 for performing a communication such as an E-mail or the like with the outside. As such a schedule managing apparatus to which the invention is applied, proper information equipment such as portable information terminal, personal computer, or the like is included. The CPU 10 has a schedule managing module 26 which is realized by a program control. The schedule managing module 26 is realized as a function of application programs which are provided as, for example, PIM and PDA. The application program which is provided as PIM or PDA supports a schedule managing function, a ToDo managing function, an address book managing function, further, a mail managing function, and the like. In the schedule managing process of the invention, a schedule management is performed by properly combining two functions of the schedule managing function and ToDo managing function.

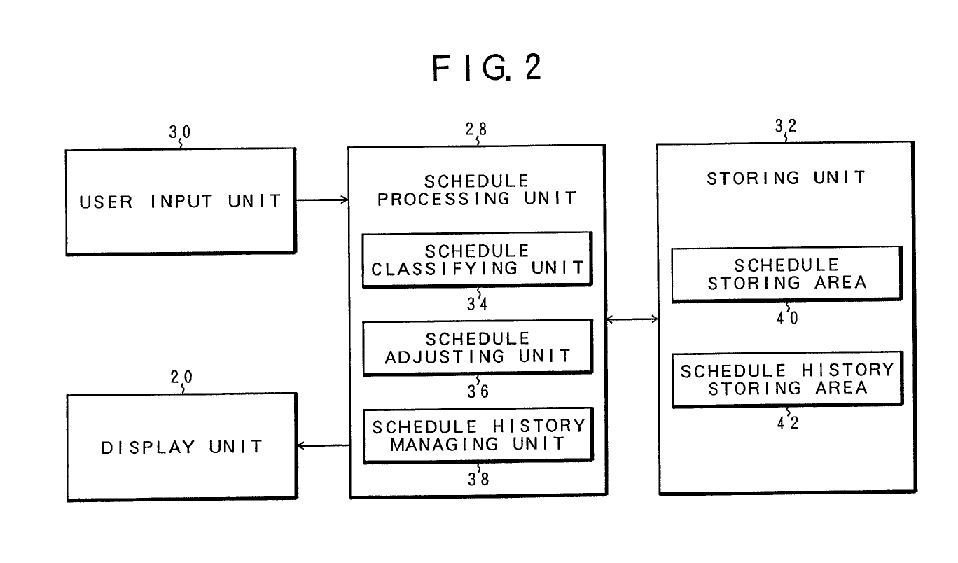

FIG. 2 is a functional block diagram of the invention which is realized by the schedule managing module 26 provided for the CPU 10 in FIG. 1. The schedule managing module 26 comprises a schedule processing unit 28, a user input unit 30, and a storing unit 32 and a display to the user is realized by the display unit 20. The schedule processing unit 28 has a schedule classifying unit 34, a schedule adjusting unit 36, and a schedule history managing unit 38. The storing unit 32 has a schedule storing area 40 and a schedule history storing area 42. The schedule classifying unit 34 in the schedule processing unit 28 classifies a new schedule inputted from the user input unit 30 into a schedule type of either a term type schedule or a period type schedule. The term type schedule is a schedule of the type in which it is necessary to be conscious of the designated date/time as a term of the operation and can be also called a completion term instructing type. The period type schedule is a schedule of the type in which it is necessary to assure a designated certain period for the operation and can be also called a participation term instructing type schedule. As schedule input information for classifying the newly inputted schedule in the schedule classifying unit 34 as mentioned above into the term type or period type, items regarding the date/time, place, contents, and the like are provided from the user input unit 30. In the embodiment of the invention, a forming picture plane of a ToDo list is used for inputting the schedule information by the user input unit 30. Therefore, as schedule information of a new schedule to the schedule classifying unit 34, an item regarding the date/time, an item regarding the place, an item regarding persons concerned, an item regarding the contents, an item regarding priority, and items such as schedule adjustment and the like regarding the system which are inputted to the ToDo list are included. On the basis of those items, the schedule is classified into the period type schedule or term type schedule. In the case where the new schedule inputted from the user input unit 30 overlaps with the existing schedule (with respect to the time) which has already been registered in a schedule list in the schedule storing area 40 in the storing unit 32, the schedule processing unit 28 adjusts the schedules on the basis of the schedule type classified by the schedule classifying unit 34, namely, in accordance with whether it is the term type or period type. The schedule adjustment by the schedule adjusting unit 36 can be classified into the following three adjusting modes.

I. Adjustment of the overlapped schedules of the term type and term type

II. Adjustment of the overlapped schedules of the period type and period type

III. Adjustment of the overlapped schedules of the period type and term type

First, with respect to the overlapped schedules of the term type and term type, even if both the new schedule and the existing schedule are registered in the schedule list, there is no problem. Therefore, the term type new schedule is assembled as it is into the schedule list. With regard to the overlapped schedules of the period type and period type, priority of both of them is compared, the schedule of the high priority is left, and the schedule of the low priority is deleted. The schedule deleted by the schedule adjustment is registered in the schedule history storing area 42 in the storing unit 32. When the priority of the overlapped schedules of the period type and period type is the same, one of the schedules is left in accordance with a preset condition. As a condition of the schedule adjustment in the case where the priority is the same, one of the following three conditions can be set.

I. User's selection

II. Selection of the existing schedule

III. Selection of the new schedule

Further, the adjustment of the overlapped schedules of the period type and term type is divided into the case where priority of the term type schedule is high and the case where priority of the term type schedule is low. When the priority of the term type schedule is higher than that of the period type schedule, the schedules are adjusted so as to move the term type schedule to the period start position of the term type schedule. On the contrary, when the priority of the term type schedule is lower than that of the period type schedule, the schedules are adjusted so as to move the term type schedule to the period end position of the period type schedule. If the term type schedule is moved for the purpose of the adjustment with the period type schedule, the initial position before the movement is stored in a system area of a schedule record and if the term type schedule which became the adjustment target after that is deleted, such an initial position is used for returning the moved term type schedule to the initial position. When the process for deleting the existing schedule registered in the schedule list in the schedule storing area 40 is performed, the schedule history managing unit 38 registers the deleted schedule into the schedule history storing area 42 in the storing unit 32 without deleting it. Thus, by searching the schedule history storing area 42 as necessary, the schedule which has already been deleted from the schedule list can be easily returned to the schedule. Further, in the invention, not only the mere storage of the schedule for the deleting process but also the deleted schedule in the case where it was deleted due to the adjustment of the new schedule and the existing schedule by the schedule adjusting unit 36 is stored in the schedule history storing area 42, and if the existing schedule which became a cause of deletion is deleted after that, the stored schedule overlapped with the deleted schedule is searched by searching the schedule history storing area 42, thereby allowing the searched schedule to be recovered in the schedule list. The schedule history managing unit 38 also simultaneously executes a movement recovering process for searching the schedule storing area 40 at the time of the deletion of the schedule, searching the term type schedule in which the schedule adjustment was performed before between the existing schedule and the deleted schedule and whose position was moved, and returning the searched term type schedule to the initial position.

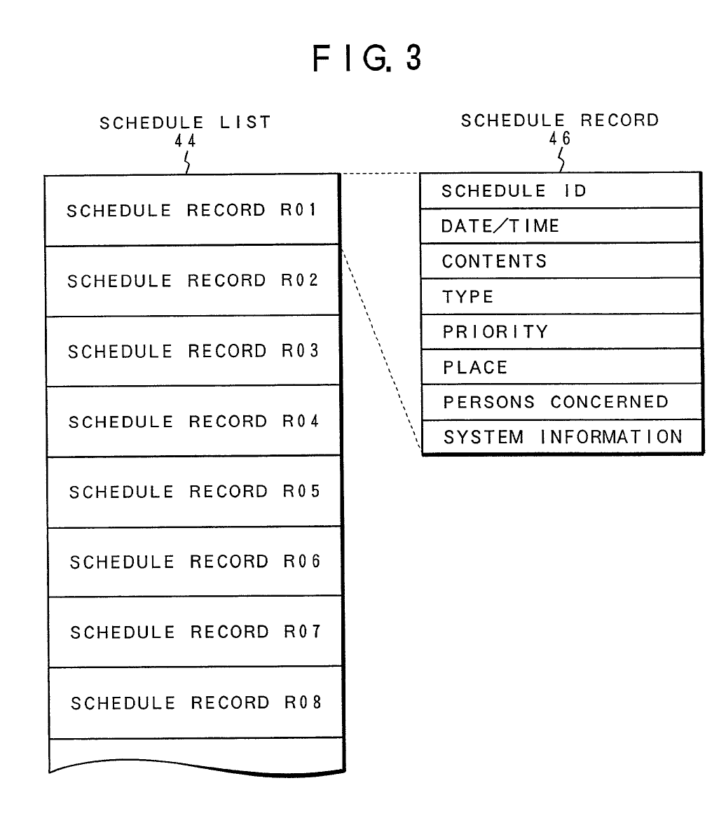

FIG. 3 is an explanatory diagram of the schedule list registered in the schedule storing area 40 in the storing unit 32 in FIG. 2. A schedule list 44 is constructed by, for example, schedule records R01, R02, R03, . . . , and R08. As representatively shown on the right side with respect to the schedule record R01, each of the schedule records R01, R02, R03, . . . , and R08 has schedule information inputted by the ToDo list formed by the user input unit 30 in FIG. 2. The schedule record according to the ToDo list has the following contents. Subsequent to a schedule ID serving as an identifier of the schedule, items regarding the date/time, contents, type of schedule, priority, place, persons concerned, and system information are described. Explaining in further detail, as an item regarding the date/time, an input date/time of the schedule, a designated term or designated period, further, a necessary date, and the like are included. As an item regarding the contents, persons who will participate in a conference, persons whom it is necessary to report, and the like are described. A message “what and how to do?” is described in the item regarding the contents. As an item regarding the type, either the term type or the period type serving as a schedule type classified by the schedule classifying unit 34 in FIG. 2 is described. As an item regarding the priority, the priority of the schedules is expressed by some format. For example, they are described by a format such that the highest priority is set to A, the second highest priority is set to B, further, the third priority is set to C, and the priority which is not specified is set to Z. As an item regarding the place, a destination of presentation, a movement destination, a place of assembly, a place of conference, and the like are described. As an item regarding the persons concerned, persons who will participate, persons whom it is necessary to report, and the like are described. Further, as an item regarding the system information, information regarding a schedule adjustment result showing whether the schedule has been moved from the inherent designated term or period due to the schedule adjustment or not is described.

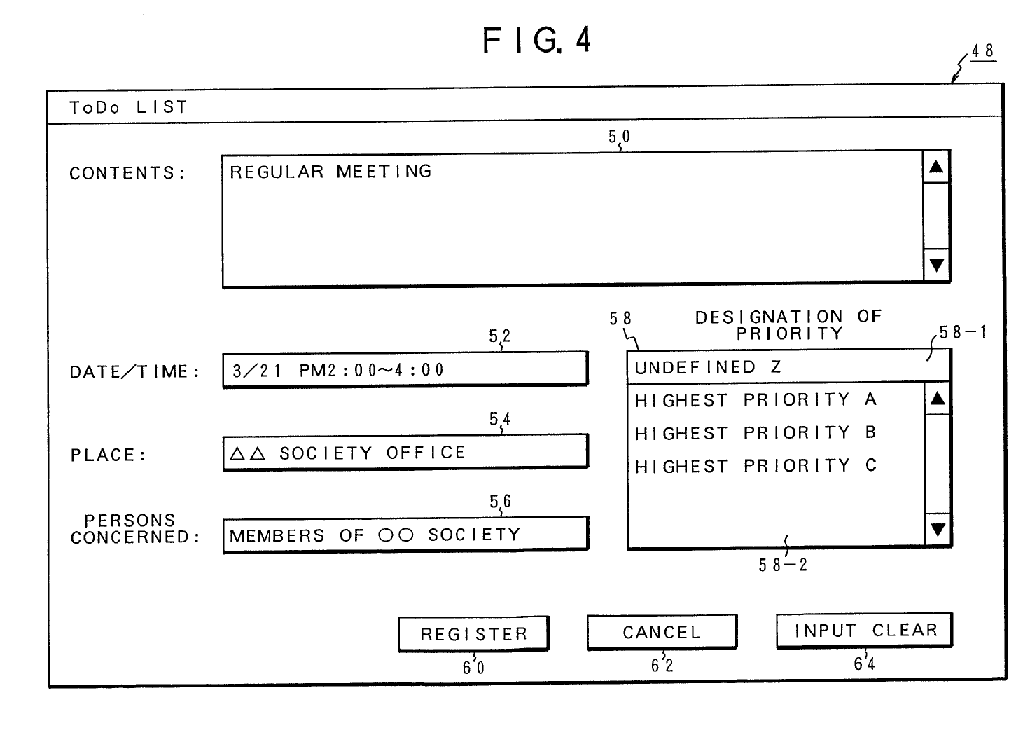

FIG. 4 is an explanatory diagram of a ToDo list forming picture plane which is used for inputting the schedule information by the user input unit 30 in FIG. 2. A ToDo list forming picture plane 48 has an inputting function corresponding to the items of the schedule records in FIG. 3. That is, a contents describing unit 50, a date/time describing unit 52, a place describing unit 54, a person concerned describing unit 56, and a priority designating unit 58 are provided for the ToDo list forming picture plane 48. Among them, a free format which can freely describe the information regarding the date/time is applied to the date/time describing unit 52, instead of a fixed format in which year, day, time, and the like have fixedly been determined like a conventional ToDo list forming picture plane. Therefore, as information regarding the date/time, the user can easily describe the day, time, term, and the like by a free format as necessary. In the priority designating unit 58, the present designated priority is displayed in an upper designation frame 58-1 and this designated priority can be properly selected from a lower selection area by clicking a mouse. Further, a register button 60, a cancel button 62, and an input clear button 64 are provided in the lower portion of the ToDo list forming picture plane 48. When the register button 60 is operated upon completion of the input of necessary items on the ToDo list forming picture plane 48, the schedule record with the structure of FIG. 3 is formed and supplied from the user input unit 30 to the schedule processing unit 28 in FIG. 2. The cancel button 62 is used when the ToDo list forming process is cancelled. The input clear button 64 is used to clear the picture plane to an initial state when a description is wrong in each describing unit.

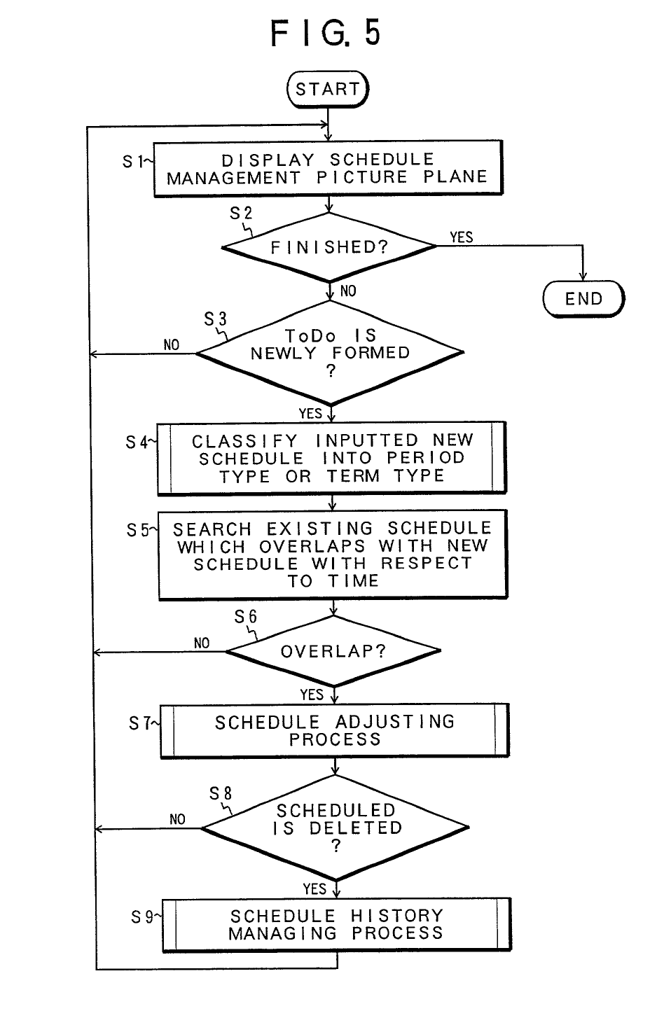

FIG. 5 is a flowchart showing a procedure of the whole schedule managing process according to the invention in FIG. 2. When a schedule managing module of the invention is activated, a menu picture plane serving as a schedule management picture plane is displayed in step S1. Subsequently, in step S2, the presence or absence of the end is discriminated. If it is not finished, step S3 follows and whether the ToDo list has been newly formed by the ToDo list forming picture plane 48 in FIG. 4 by using the menu picture plane or not is discriminated. When the ToDo list forming picture plane 48 in FIG. 4 is formed and the register button 60 is operated, whether the ToDo list has been newly formed or not is discriminated in step S3. If YES, step S4 follows and a process for classifying the inputted new schedule into the period type or term type is performed by the schedule classifying unit 34 in FIG. 2. Step S5 follows and the existing schedule which overlaps with the new schedule with respect to the time is searched by the schedule adjusting unit 36 in FIG. 2. If it is determined in step S6 that they are overlapped, step S7 follows and a schedule adjusting process is performed. In step S8, whether the existing schedule has been deleted or not is discriminated. If the existing schedule was deleted, step S9 follows and a schedule history managing process is performed by the schedule history managing unit 38 in FIG. 2.

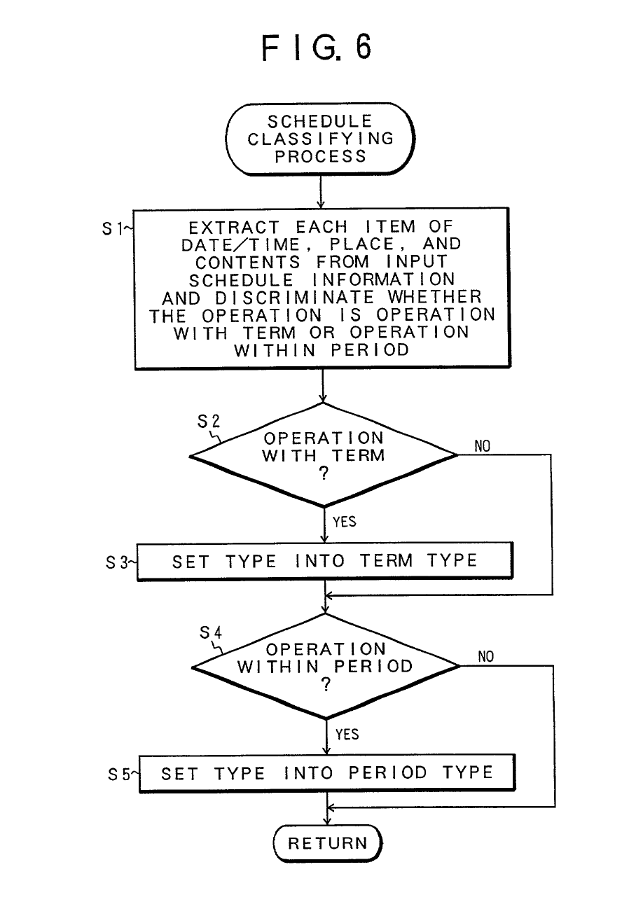

FIG. 6 is a flowchart for the classifying process of the inputted new schedule in step S4 in FIG. 5. In the schedule classifying process, in step S1, the items of the date/time, place, and contents are extracted from the input schedule information derived from the ToDo list forming picture plane and whether the new schedule corresponds to an operation with term or an operation within period is discriminated. If it is determined in step S2 that the new schedule corresponds to the operation with term, the type is set to the term type schedule in step S3. If it is decided in step S4 that the new schedule corresponds to the operation within period, the type is set to the period type schedule in step S5.

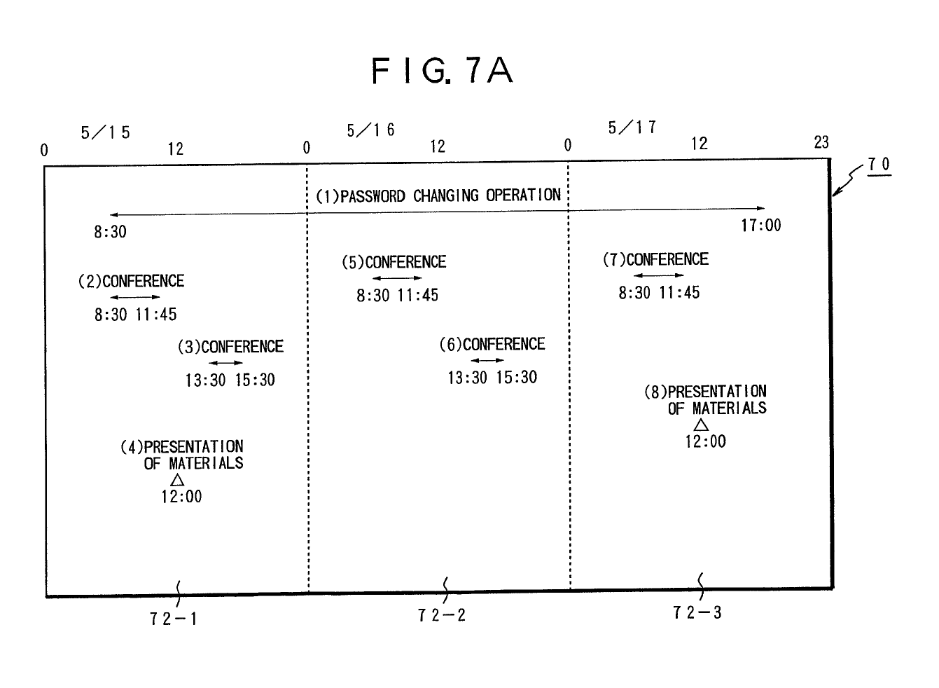

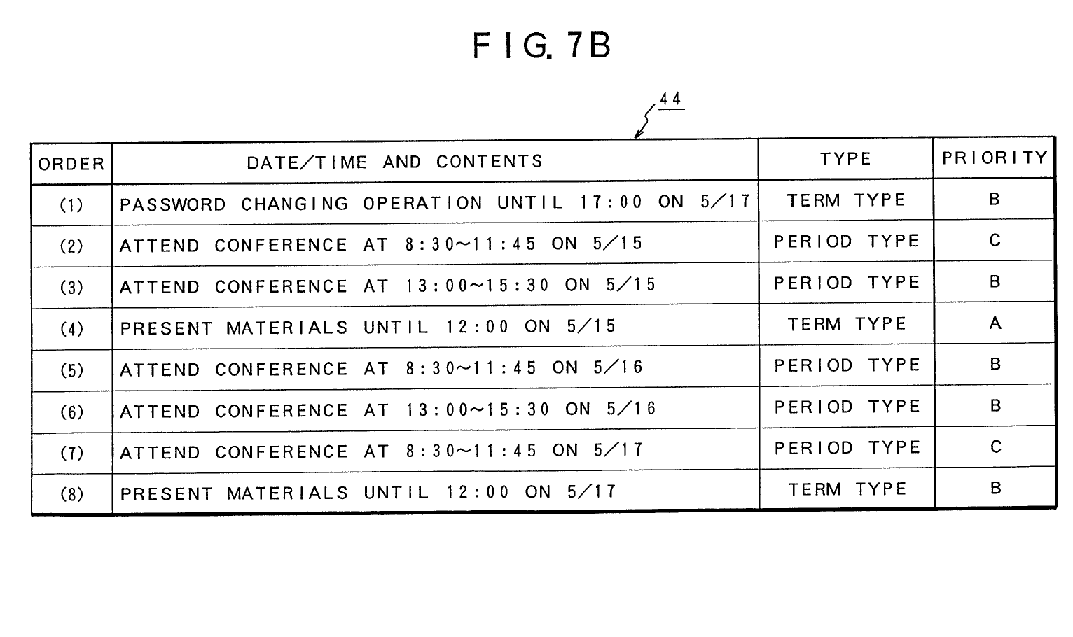

FIGS. 7A and 7B show a specific example of a schedule table based on the schedule list stored through the schedule classifying process in FIG. 6. FIG. 7A shows the schedule table and it is displayed on the basis of the schedule list of FIG. 7B. A schedule table 70 in FIG. 7A is a part of, for example, a weekly schedule table and a schedule display of three days of three areas 72-1, 72-2, and 72-3 of May 15 (5/15), May 16 (5/16), and May 17 (5/17) are shown as an example. The schedule displayed on the schedule table 70 is formed from the schedule list 44 in FIG. 7B. The schedule list 44 has item numbers (1) to (8) corresponding to the schedule IDs and each schedule has a date/time, contents, a type, and further, priority. Naturally, the other items are omitted here for the purpose of simplicity of explanation. Three schedules of the item Nos. (1), (4), and (8) are set to the term type and the schedules of the remaining item Nos. (2), (3), (5), (6), and (7) are set to the period type. The priority A, B, and C is sequentially designated from the high order. The display of the schedules of the term type and period type in the schedule table 70 in FIG. 7A will now be simply explained hereinbelow. First, in the term type schedule of the item No. (1), the operation term is set to “5/17 17:00” and there is a long interval between the input timing and the term. Therefore, as an example showing such a fact, in this case, since the input date/time is equal to “5/15 8:30”, a time interval from the start of the operation to the end thereof is shown by arrows. In the other schedules of the item Nos. (4) and (8), the term and the date/time are shown by triangular markers. In the period type schedule, as shown by the item No. (2), a time interval from the start time of the period to the end time of the period is shown in the area 72-1 of May 15 by arrows and, further, the item number, contents, start time, and end time are displayed. To distinguish the term type from the period type, their display colors can be also made different when they are displayed.

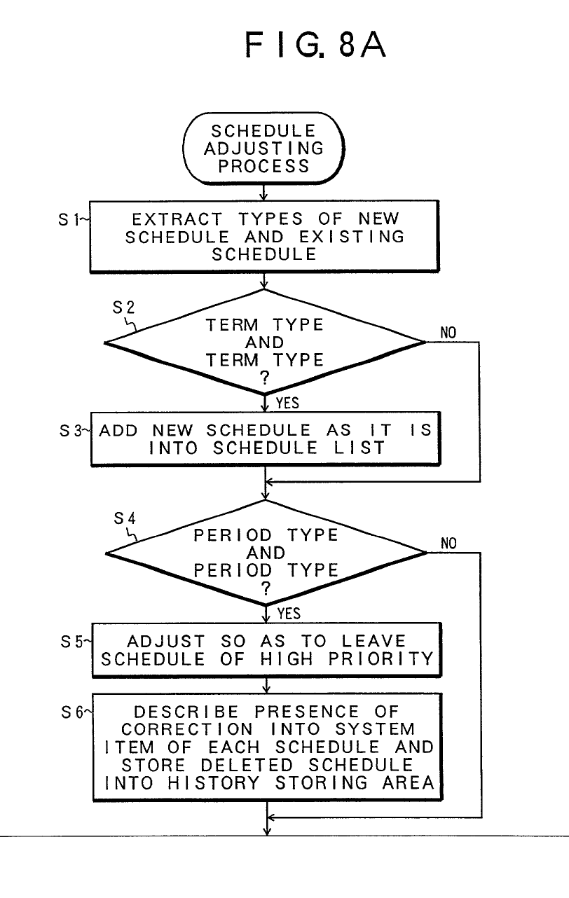

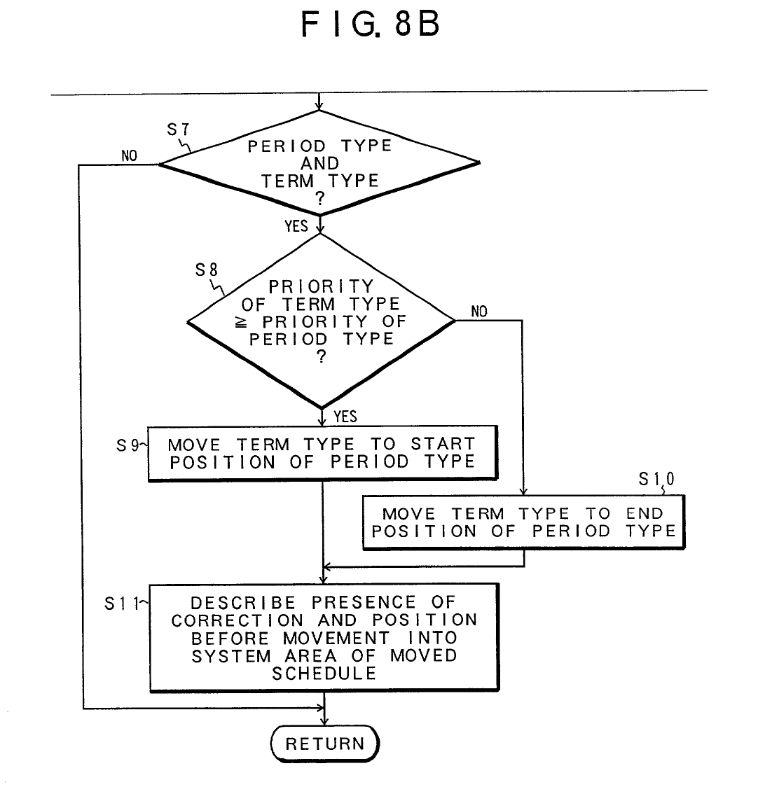

FIGS. 8A and 8B are flowcharts showing the schedule adjusting process shown in step S7 in FIG. 5 as a subroutine. In this schedule adjusting process, first, in step S1, the types of the new schedule and existing schedule in which it is determined that they are overlapped with respect to the time are extracted. As mentioned above, one of the following combinations exists between those two schedules.

I. Term type and term type

II. Period type and period type

III. Period type and term type

Therefore, in each of steps S2, S4, and S7, the combination of the term type and term type, the combination of the period type and period type, and the combination of the period type and term type are discriminated. If it is determined in step S2 that the new schedule and existing schedule are set to the term type and term type, step S3 follows and the new schedule is assembled as it is into the schedule list. If it is determined in step S4 that the new schedule and existing schedule are set to the period type and period type, step S5 follows and the schedules are adjusted so as to leave the schedule having the high priority. In this case, in step S6, the presence of the correction is described in the system item of each schedule and, further, the deleted period type schedule is stored in the schedule history storing area 42 provided in the storing unit 32 in FIG. 2. Further, if it is determined in step S7 that the new schedule and existing schedule are set to the period type and term type, step S8 follows and the priority of the term type and that of the period type are compared. If the priority of the term type is higher than that of the period type, step S9 follows and the term type schedule is moved to the start position of the period type. On the contrary, if the priority of the term type is lower than that of the period type, step S10 follows and the term type schedule is moved to the end position of the period type. If the schedule adjustment to move the position of the term type is performed in step S9 or S10, the presence of the correction and the position before the correction are described in the system area of the moved schedule in step S11. The processing routine is returned to the routine of FIG. 5.

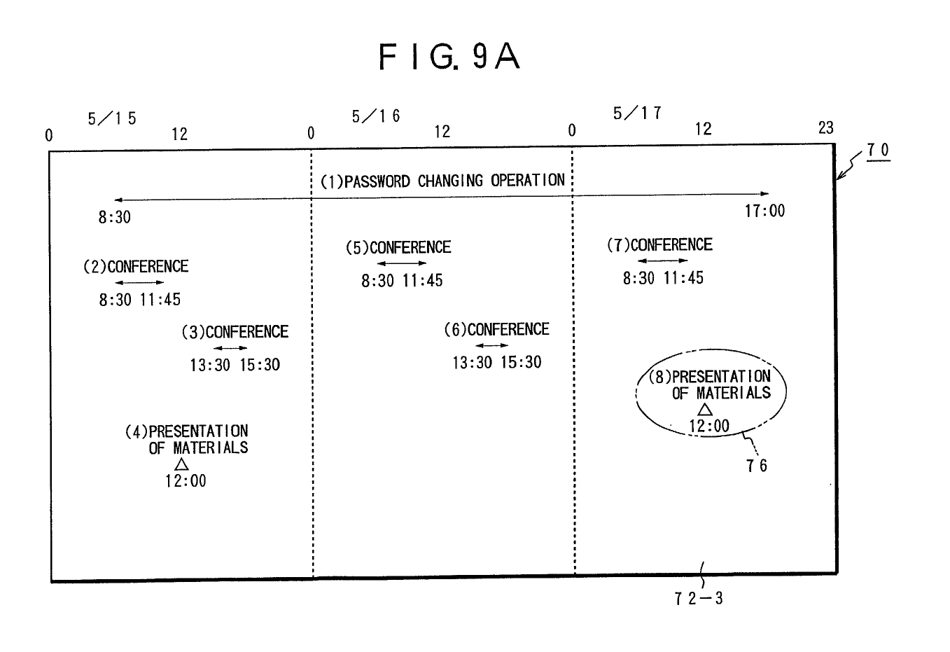

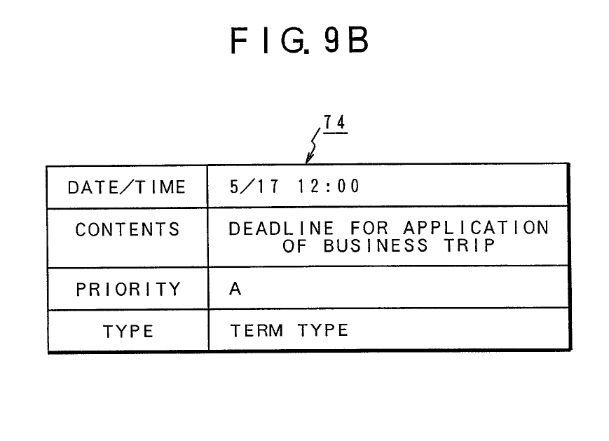

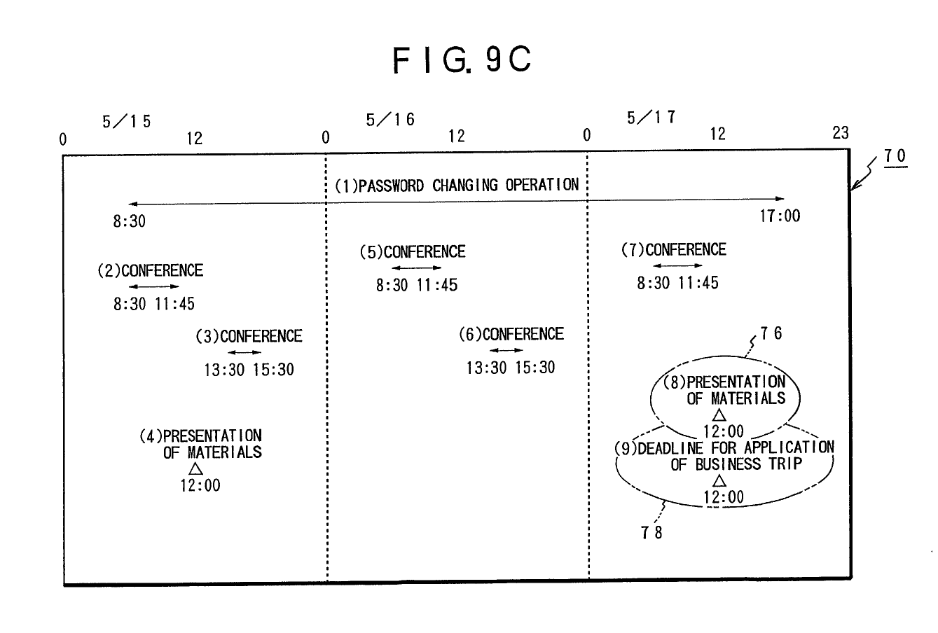

FIGS. 9A to 9C are specific explanatory diagrams of the schedule adjustment in the case where both the new schedule and the existing schedule are set to the term type in step S3 in FIGS. 8A and 8B. FIG. 9A relates to the schedule table 70 of the same contents as those in FIG. 7A and shows the schedule table before the schedule adjustment. Now, assuming that a new schedule in FIG. 9B is inputted, since the date/time of a new schedule record 74 is equal to “5/17 12:00”, the schedule record 74 overlaps with an existing schedule 76 which has been set in the area 72-3 of May 17 in the existing schedule table in FIG. 9A. Since the existing schedule 76 has the item No. (8), it is set to the term type with reference to FIG. 7B. Therefore, both the new schedule record 74 and existing schedule 76 are overlapped as term type schedules. When two schedules are the term type and overlapped as mentioned above, even if the terms of both of them are simultaneously set, there is not particularly a problem as schedules. Therefore, a new schedule 78 is assembled as an item No. (9) so as to overlap with the existing schedule 76 as shown in FIG. 9C.

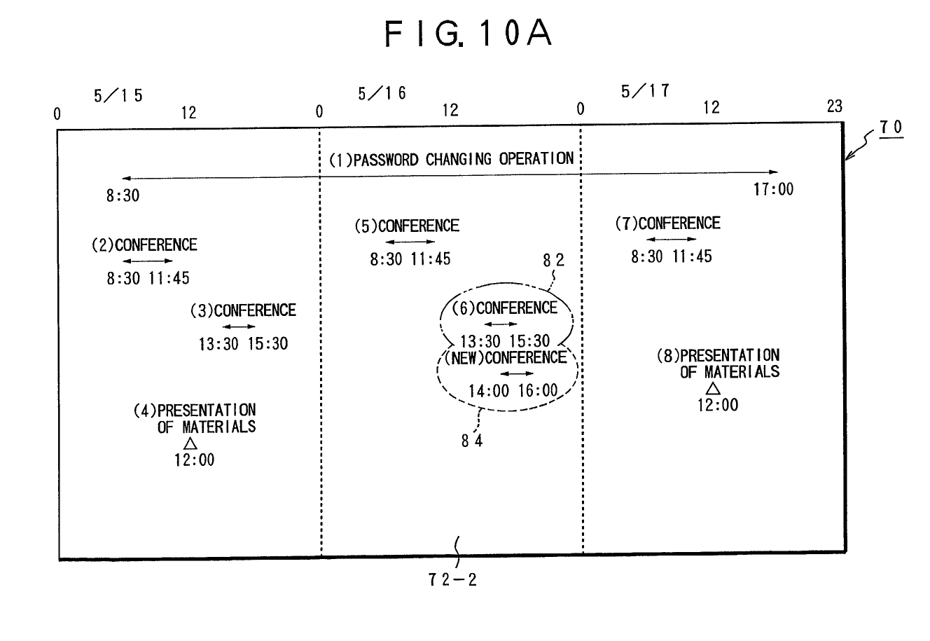

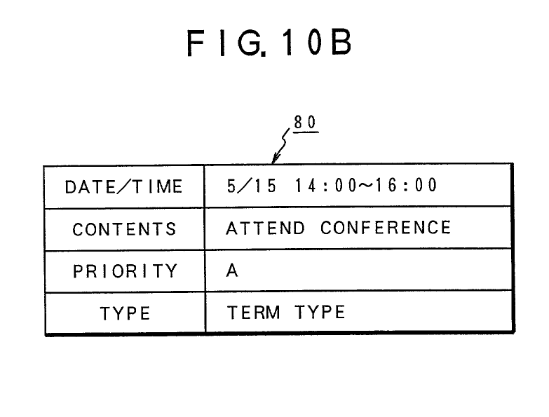

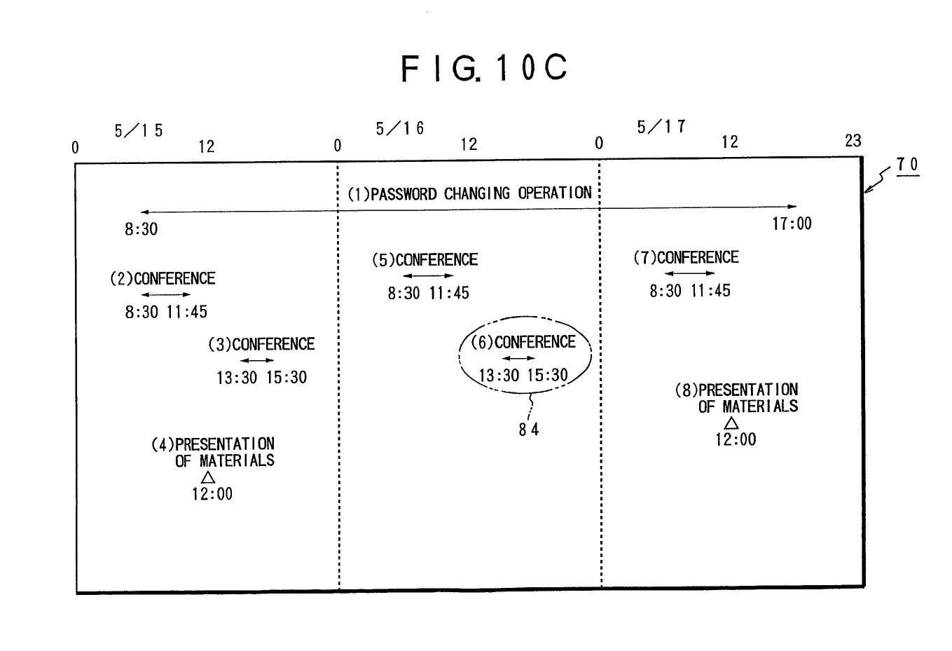

FIGS. 10A to 10C show a specific example of the schedule adjustment in the case where both the new schedule and the existing schedule are set to the period type in step S5 in FIG. 8A. FIG. 10A shows the same schedule table 70 before the schedule adjustment as that in FIG. 7A. It is assumed that a new schedule record 80 in FIG. 10B is inputted in this state. The date/time of the new schedule record 80 is set to “5/15 14:00˜16:00” and a time zone of the new schedule record 80 overlaps with that of an existing schedule 82 set in the area 72-2 of May 16 in the existing schedule table 70. In the existing schedule 82 which overlaps with the new schedule record 80, the item No. is equal to (6), the type is the period type as shown in FIG. 7B, and the priority is set to “B”. If a new schedule 84 in FIG. 10B is set, it is shown by an area surrounded by a broken line on the lower side of the existing schedule 82 in FIG. 10A. If the new schedule 84 is set as it is for the existing schedule 82 as mentioned above, the periods are overlapped and it is not satisfied as a schedule. Therefore, the priority is first compared to adjust the existing schedule 82 and new schedule 84. The priority of the new schedule 84 is set to the highest priority “A”. The priority of the existing schedule 82 is set to the second highest priority “B” with reference to FIG. 7B. Therefore, when two period type schedules are overlapped, a schedule adjustment for leaving the new schedule 84 of the high priority and deleting the existing schedule 82 of the low priority is performed. Thus, the new schedule 84 of the high priority remains in the schedule table 70 as shown in FIG. 10C. At this time, although the existing schedule 82 before the adjustment is deleted, the schedule record of the deleted existing schedule 82 is registered in the schedule history storing area 42 provided for the storing unit 32 in FIG. 2.

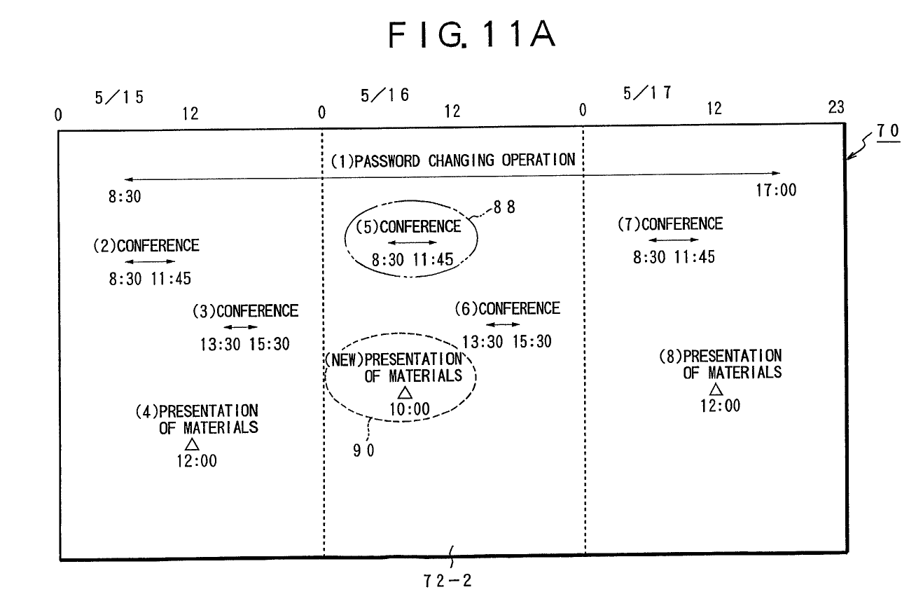

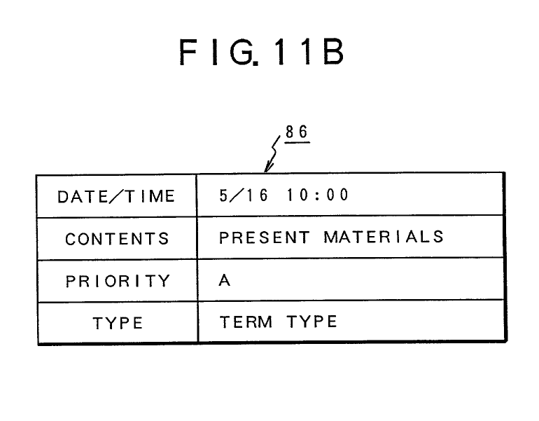

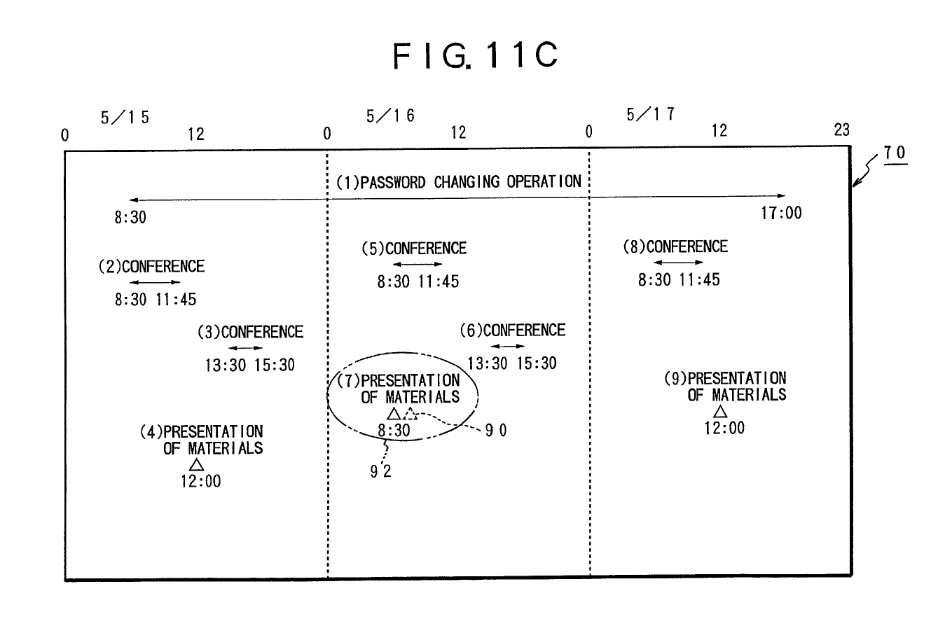

FIGS. 11A to 11C show a specific example of the schedule adjustment in the case where the new schedule and the existing schedule are set to the term type and the period type and are overlapped in steps S7 to S11 in FIG. 8B. FIG. 11A shows the same schedule table 70 before the adjustment as that in FIG. 7A. Now, assuming that a new schedule record 86 in FIG. 11B is inputted to this schedule table, an existing schedule 88 and a new schedule 90 of May 16 in FIG. 11A are overlapped. The new schedule 90 is set to the term type and its term is set to “5/16 10:00” and overlaps with a period “5/16 8:30˜11:45” of the existing schedule 88. When the term type schedule and the period type schedule overlap as mentioned above, priority of both of them is compared. The priority of the new schedule 90 is set to the highest priority “A” with reference to FIG. 11B. On the other hand, the priority of the existing schedule 88 is set to “B” with reference to FIG. 7B because the item No. is equal to (5). Therefore, since the priority of the term type schedule 90 is higher, in this case, the term type schedule 90 is moved as a term type schedule 92 to the position of the period start time “8:30” of the overlapped period type existing schedule 88 as shown in FIG. 11C. On the contrary, when the priority of the term type schedule 90 is lower than that of the period type existing schedule 88, the term type schedule 90 is moved as a term type schedule 92 to the position of the end time “11:45” of the existing schedule 88. Further, as shown in FIG. 1C, when the position of the term type schedule 92 is moved, the position “5/16 10:00” before the movement is stored in a system area of the new schedule record.

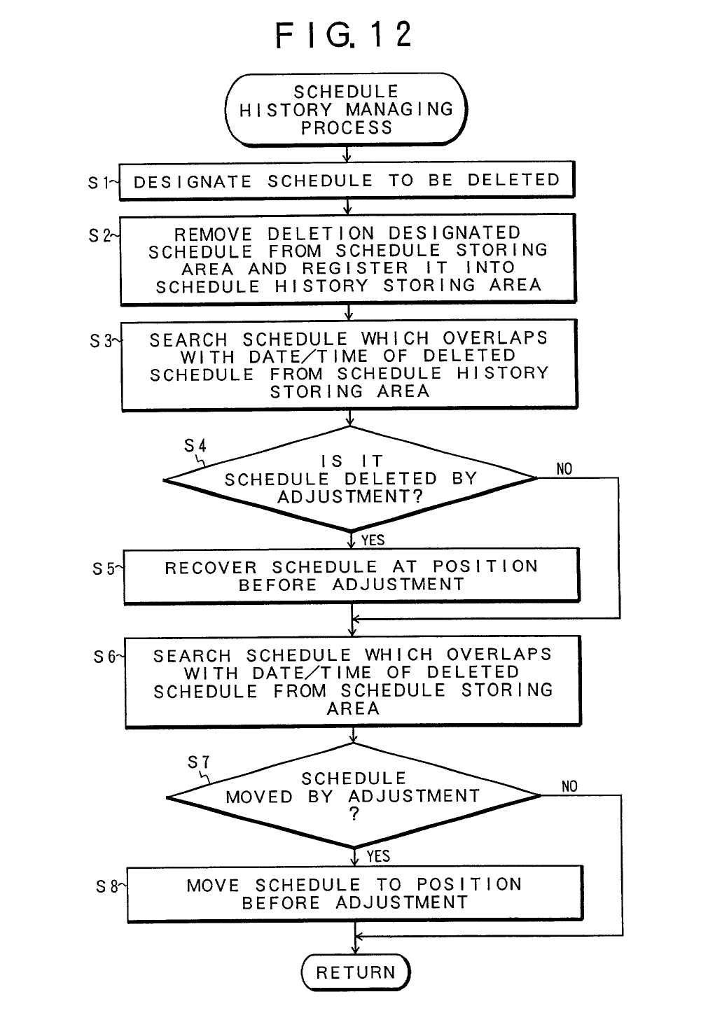

FIG. 12 is a flowchart showing the details of the schedule history managing process in step S9 in FIG. 5 as a subroutine. In the schedule history managing process, first, in step S1, an existing schedule to be deleted is designated on the display picture plane of the schedule table. When the deletion schedule is designated, in step S2, the designated schedule is removed from the schedule storing area, namely, the schedule list and registered into a schedule history storing area. After completion of the deletion of the schedule and the registration of the schedule into the schedule history storing area, a schedule whose date/time overlaps with that of the deletion schedule is searched from the schedule history storing area in step S3. If the overlapped schedule can be searched from the schedule history storing area, whether the searched schedule is the schedule deleted due to the adjustment or not is discriminated in step S4 with reference to the system area of the searched schedule. If it is the schedule deleted due to the adjustment, step S5 follows and the schedule is recovered to the position before the adjustment. That is, it is replaced to the position of the deleted schedule information in the schedule history storing area. Further, a schedule whose date/time overlaps with that of the deleted schedule is searched from the schedule history storing area in step S6. The schedule whose position was moved by the previous schedule adjustment can be searched by this search. Subsequently, in step S7, whether the searched schedule is the schedule moved due to the adjustment or not is discriminated. Such a discrimination can be made by checking whether the presence of the adjustment has been described in the system area of the searched schedule or not. If it is the schedule moved due to the adjustment, step S8 follows and the schedule is moved to the position before the adjustment.

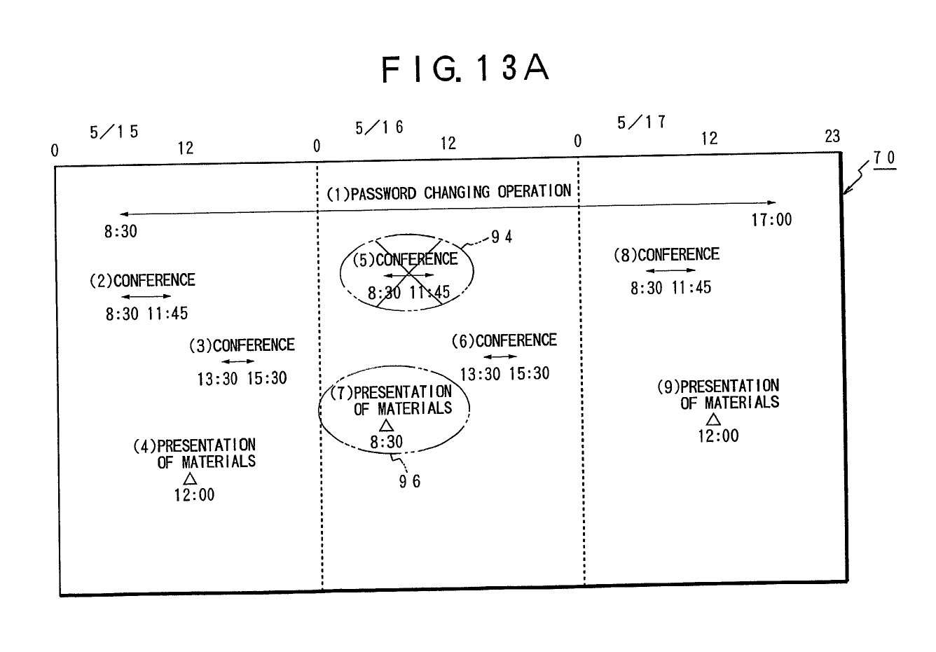

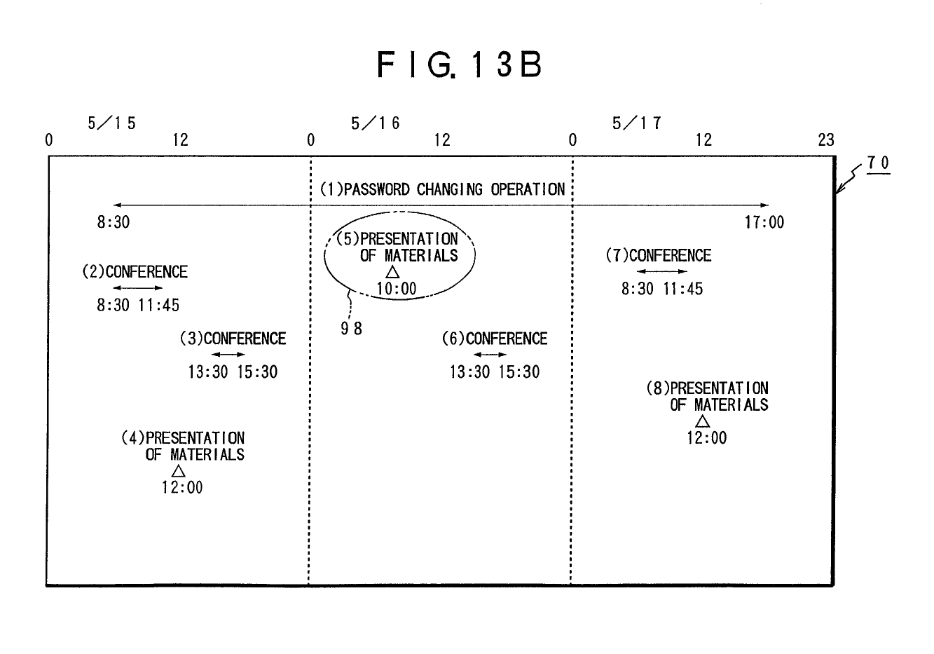

FIGS. 13A and 13B show a specific example of the schedule history managing process in FIG. 12 and relates to an example in the case where the existing schedule is deleted and the schedule whose position is moved due to the schedule adjustment is returned to the initial position. FIG. 13A is a schedule table which is obtained after completion of the schedule adjustment in FIG. 11C. With respect to the schedule table 70, for example, it is assumed that a schedule 94 of the item No. (5) of May 16 is deleted. When the schedule 94 is deleted, the schedule list is deleted from the schedule storing area and the schedule list is newly registered in the schedule storing area. Subsequently, a schedule whose date/time overlaps with that of the deleted schedule 94 is searched from the schedule history storing area. In this case, however, the relevant schedule is not searched. Subsequently, a schedule whose date/time overlaps with that of the deleted schedule is searched from the schedule history storing area. An adjusted schedule 96 in FIG. 13A is searched by the above search. Since the adjusted schedule 96 has information indicative of “the presence of adjustment” and the initial position “5/16 10:00” before the adjustment as system information, it is regarded as a recovery schedule 98 obtained by returning to the initial position as shown in FIG. 13B.

The present invention provides a computer-readable recording medium in which a schedule managing program having a processing function shown in the functional block diagram of the schedule managing module in FIG. 2 has been stored. As an embodiment of the recording medium, there are a removable and portable recording medium such as CD-ROM, floppy disk, or the like, a storing device of a program provider who provides the program via a line, and further, a memory such as RAM, hard disk, or the like of a processing apparatus in which the program has been installed. The program provided by the recording medium is installed in the processing apparatus and executed on a main memory.

According to the invention as described above, the new schedule inputted by the user is classified into the term type in which it is necessary to be conscious of the designated date/time as a term of the operation or the period type in which it is necessary to assure a designated certain period for the operation in accordance with the contents of the new schedule and the schedule type is displayed in the schedule table. Therefore, the user can recognize the schedule in which a judgment about whether he should be conscious of the term (deadline) or be conscious of the participation for a certain period of time with respect to each schedule has been clearly grasped.

In the case where the new schedule is inputted and it overlaps with the existing schedule, the schedules are automatically adjusted in accordance with the types of the overlapped schedules, namely, the term type and period type, and further, the priority, so that a troublesomeness of the schedule adjustment of the user can be remarkably reduced. Moreover, since the adjustment of the inputted new schedule and the existing schedule is automatically performed, an underground in the case where the user performs a further fine adjustment can be obtained owing to the automatic adjusting function.

Furthermore, by storing and managing the history of the schedules, the deleted existing schedule remains as it is without being erased and can be recovered to the schedule as necessary. Further, the schedule which was deleted by the schedule adjustment or whose position was changed can be recovered to the original schedule or returned to the initial position due to the deletion of the existing schedule. Also in this point, the schedule recovery and adjustment at the time of the deletion of the schedule are unnecessary, so that the troublesomeness of the user is reduced by an amount corresponding to them. An underground in case of performing a further fine adjustment can be simplified by the recovery associated by the schedule deletion or the moving function to the initial position.

Although the embodiment has been described with respect to an example in case of inputting the schedule information by using the ToDo list forming picture plane 48 as shown in FIG. 4, so long as the schedule information including the items such as contents showing the operation items, date/time, place, persons concerned, designation of priority, and the like is inputted, the invention incorporates the management of the schedule information using a proper input picture plane irrespective of the ToDo list forming picture plane.

Although the embodiment has been described with respect to the example of using the weekly schedule table as a schedule table which is formed and displayed by the schedule management, another monthly schedule table or daily schedule table can be also displayed on the basis of the schedule management result according to the invention in a manner similar to that mentioned above.

Further, the display format of the schedule table shown in the embodiment is not limited to that mentioned above but a schedule table of a proper format construction can be also displayed.

The invention is not limited to the above embodiment but incorporates many proper modifications without losing the objects and advantages of the invention. Further, the invention is not limited by the numerical values shown in the embodiment.

What is claimed is:

1. A schedule managing apparatus for managing schedules, comprising:
a schedule classifying unit which classifies an inputted schedule into any type on the basis of its information; and
a schedule adjusting unit which adjusts the schedules on the basis of each schedule type in the case where said inputted schedule overlaps with an existing schedule with respect to the time.

2. An apparatus according to claim 1, wherein said schedule classifying unit classifies the inputted schedule into any type of a term type schedule in which designated date/time is set to a term of an operation or a period type schedule in which a designated certain period is assured for the operation.

3. An apparatus according to claim 2, wherein said schedule classifying unit classifies the inputted schedule into any type of said term type schedule or said period type schedule on the basis of items regarding date/time, place, and contents included in the inputted new schedule or the like.

4. An apparatus according to claim 2, wherein said schedule classifying unit classifies the inputted schedule into any type of said term type schedule or said period type schedule on the basis of schedule information including an item regarding date/time, an item regarding a place, an item regarding persons concerned, an item regarding the contents, an item regarding priority, and an item such as a schedule adjustment or the like regarding a system which are inputted to a ToDo list.

5. An apparatus according to claim 2, wherein in the case where the inputted new schedule and the existing schedule are the term type schedules and terms of both of said schedules overlap, said schedule adjusting unit assembles the new schedule as it is without adjusting both of said schedules.

6. An apparatus according to claim 2, wherein in the case where the inputted new schedule and the existing schedule are the period type schedules and periods of both of said schedules overlap, said schedule adjusting unit adjusts the schedules so as to leave the schedule of high priority.

7. An apparatus according to claim 6, wherein in the case where priority of the inputted new schedule and that of the existing schedule are the same, said schedule adjusting unit leaves the schedule selected in accordance with a preset condition.

8. An apparatus according to claim 7, wherein as a condition in the case where the priority is the same, said schedule adjusting unit sets a user's selection, a selection of the existing schedule, or a selection of the new schedule.

9. An apparatus according to claim 2, wherein in the case where one of the inputted new schedule and the existing schedule is a period type schedule and the other is the term type schedule, if priority of the term type schedule is high, said schedule adjusting unit adjusts the schedules so as to move the term type schedule to a period start position of the period type schedule.

10. An apparatus according to claim 9, wherein when the priority of the term type schedule is low, said schedule adjusting unit adjusts the schedules so as to move the term type schedule to a period end position of the period type schedule.

11. An apparatus according to claim 9, further comprising a schedule history managing unit which stores the schedule deleted by the adjustment of said schedule adjusting unit and a position before the adjustment of the schedule moved due to the adjustment,
and wherein when the existing schedule is deleted, said schedule adjusting unit refers to a history stored by said schedule history managing unit and performs a recovery of the schedule deleted due to the schedule adjustment or a return of the schedule to an initial position moved due to the schedule adjustment.

12. A schedule managing method of managing schedules, comprising the steps of:
classifying an inputted schedule into any type on the basis of its information; and
adjusting the schedules on the basis of each schedule type in the case where said inputted schedule overlaps with an existing schedule with respect to the time.

13. A method according to claim 12, wherein the inputted schedule is classified into any type of a term type schedule in which designated date/time is set to a term of an operation or a period type schedule in which a designated certain period is assured for the operation.

14. A method according to claim 13, wherein the inputted schedule is classified into any type of said term type schedule or said period type schedule on the basis of items regarding date/time, place, and contents included in the inputted new schedule or the like.

15. A method according to claim 13, wherein the inputted schedule is classified into any type of said term type schedule or said period type schedule on the basis of schedule information including an item regarding date/time, an item regarding a place, an item regarding persons concerned, an item regarding the contents, an item regarding priority, and an item such as a schedule adjustment or the like regarding a system which are inputted to a ToDo list.

16. A method according to claim 13, wherein in the case where the inputted new schedule and the existing schedule are the term type schedules and terms of both of said schedules overlap, the new schedule is assembled as it is without adjusting both of said schedules.

17. A method according to claim 13, wherein in the case where the inputted new schedule and the existing schedule are the period type schedules and periods of both of said schedules overlap, the schedules is adjusted so as to leave the schedule of high priority.

18. A method according to claim 17, wherein in the case where priority of the inputted new schedule and that of the existing schedule are the same, the schedule selected in accordance with a preset condition is left.

19. A method according to claim 18, wherein as a condition in the case where the priority is the same, a user's selection, a selection of the existing schedule, or a selection of the new schedule is set.

20. A method according to claim 13, wherein in the case where one of the inputted new schedule and the existing schedule is a period type schedule and the other is the term type schedule, if priority of the term type schedule is high, the schedules are adjusted so as to move the term type schedule to a period start position of the period type schedule.

21. A method according to claim 20, wherein when the priority of the term type schedule is low, the schedules are adjusted so as to move the term type schedule to a period end position of the period type schedule.

22. A method according to claim 20, further comprising the steps of:
storing the schedule deleted by the adjustment of said schedules and a position before the adjustment of the schedule moved due to the adjustment of the schedules,
and when the existing schedule is deleted, referring to a stored history and performing a recovery of the schedule deleted due to the schedule adjustment or a return of the schedule to an initial position moved due to the schedule adjustment.

23. A computer-readable recording medium in which a schedule managing program for managing schedules has been stored, wherein said schedule managing program comprises the steps of:
classifying an inputted schedule into any type on the basis of its information; and
adjusting the schedules on the basis of each schedule type in the case where said inputted schedule overlaps with an existing schedule with respect to the time.
